(19) United States
(12) Patent Application Publication
(10) Pub. No.: US 2008/0194134 A1
(43) Pub. Date: Aug. 14, 2008

(54) CONNECTOR AND ASSEMBLING METHOD THEREOF

(76) Inventors: Chin-Tse WU, Taoyuan Hsien (TW); Yu-Shun Lee, Taoyuan Hsien (TW); Chen-Jung Chen, Taoyuan Hsien (TW); Neng-Kuei Huang, Taoyuan Hsien (TW)

Correspondence Address: BIRCH STEWART KOLASCH & BIRCH, PO BOX 747, FALLS CHURCH, VA, 22040-0747, US

(21) Appl. No.: 12/014,613

(22) Filed: Jan. 15, 2008

(30) Foreign Application Priority Data
Feb. 12, 2007 (TW) 096105006
Feb. 14, 2007 (TW) 096105411

(51) Int. Cl. H01R 13/627

(52) U.S. Cl. 439/352

(57) ABSTRACT

A connector includes a terminal base, a main housing including a first housing and a second housing, and a rear cover. The terminal base has a plurality of terminals disposed at a bottom surface of the terminal base. The first housing has a first connecting portion. The second housing has a second connecting portion. The rear cover has two third connecting portions, which are respectively connected to the first connecting portion and the second connecting portion and thus to the first housing, the second housing and the rear cover to cover the terminal base. An assembling method of the connector is also disclosed.

### CROSS REFERENCE TO RELATED APPLICATIONS

This Non-provisional application claims priority under 35 U.S.C. §119(a) on Patent Application No(s). 096105006 filed in Taiwan, Republic of China on Feb. 12, 2007, the entire contents of which are hereby incorporated by reference. This Non-provisional application also claims priority under 35 U.S.C. §119(a) on Patent Application No(s). 096105411 filed in Taiwan, Republic of China on Feb. 14, 2007, the entire contents of which are hereby incorporated by reference.

### BACKGROUND OF THE INVENTION

1. Field of Invention

The invention relates to a connector and, in particular, to a connector with a simplified connecting structure on its housing.

2. Related Art

With the rapid development of the information technology, applications of computer systems have been gradually popularized. Also, under the rapid development of the Internet technology, the computer systems can access the required data rapidly through the Internet so that the diversified information services can be provided. Thus, connecting the computers and the peripheral apparatuses through the network has become the trend in the information age.

Connectors are normally used to connect different electronic devices relating to networks. As shown in FIG. 1, a conventional connector 1 has a terminal base 10 coupled to a connecting plug of a connecting wire (not shown) for signal transmissions. Several terminals 11 are embedded into the socket of the terminal base 10, and the terminal base 10 has several pins 12 disposed on the bottom surface thereof. The terminals 11 are connected to the internal circuit (not shown) of the connector 1, so that the terminals 11 and the corresponding pins 12 can be electrically connected through the internal circuit. Therefore, when the connecting plug and terminal base 10 are coupled, the connector 1 of an electronic device can receive signals from a network. After the signals can be processed by the terminals 11 and the internal circuit, the signals are then transmitted to an external circuit via the pins 12. Accordingly, the signal processing and transceiving can be preformed.

As shown in FIG. 1, the connector 1 further includes a housing 20. The terminal base 10 is disposed in the housing 20. The housing 20 is usually made of metal in order to protect the terminal base 10 and to prevent external electromagnetic interference (EMI). The terminal base 10 and the housing 20 are assembled by sliding the terminal base 10 into the housing 20. A hook structure 21 on the housing 20 is wedged to the bottom surface of the terminal base 10. However, the hook structure 21 is too close to some of the pins 12, so that the signal of these pins 12 of the connector 1 is interfered by the hooking structure 121, thereby decreasing the signal transmission quality thereof.

Therefore, it is an important subject to provide a connector which has a housing with a simplified connecting structure and is capable of preventing interference of the pins and the housing, having lower precision requirement and production cost, and avoiding EMI for transmission signal.

### SUMMARY OF THE INVENTION

In view of the foregoing, the invention is to provide a connector which has at least one housing with a simplified connecting structure and is capable of preventing interference of the pins and the housing, having lower precision requirement and production cost, and avoiding signal transmission interference.

To achieve the above, the invention discloses a connector including a terminal base, a main housing and a rear cover. The terminal base has a plurality of terminals disposed at a bottom surface of the terminal base. The main housing includes a first housing having a first connecting portion and a second housing having a second connecting portion. The rear cover has two third connecting portions, which are respectively connected to the first connecting portion and the second connecting portion. Thus, the main housing and the rear cover can cover the terminal base.

To achieve the above, the invention also discloses a method of assembling a connector, which comprises a terminal base, a main housing including a first housing and a second housing, and a rear cover. The first housing has a first connecting portion, the second housing has a second connecting portion and the rear cover has two third connecting portions. The method includes the steps of: attaching the second housing to a side surface of the terminal base, attaching the first housing to a top surface of the terminal base, attaching the rear cover to a back surface of the terminal base, engaging one of the third connecting portions of the rear cover with the second connecting portion of the second housing, and engaging the first connecting portion of the first housing with the other one of the third connecting portions of the rear cover.

As mentioned hereinabove, the connector and the assembling method thereof according to the invention have the following features. The third connecting portions of the rear cover are connected to the first connecting portion of the first housing and the second connecting portion of the second housing by engaging, for example, so that the rear cover firstly engages with the first housing and then the second housing engages with the rear cover. Thus, the main housing and the rear cover can be combined together. Compared to the related art, the connecting portions of the housings of the invention are combined together without welding. Thus, the invention can prevent the housing from turning over and loosening and from interfering with the terminals, have high precision and low cost, prevent a transmitted signal from being interfered and thus enhance the reliability of the connector.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional connector;

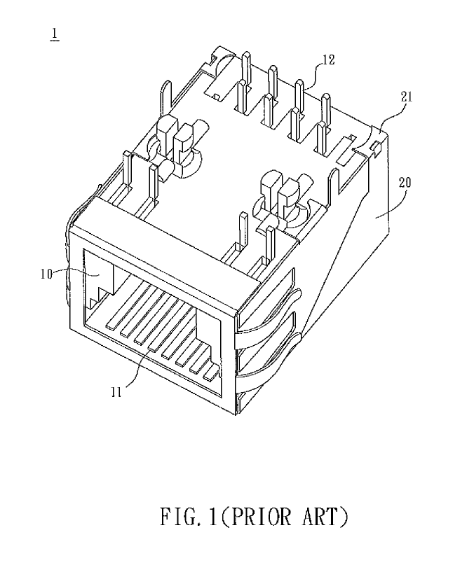

FIG. 2 is a schematic illustration showing a connector according to an embodiment of the invention;

FIG. 3 is an exploded view showing the connector of FIG. 2; and

FIG. 4 is a flow chart showing an assembling method of the connector according to the embodiment of the invention.

FIG. 5 is a schematic view of another connector according to another embodiment of the invention and a cross-sectional view of an enlarged part along AA direction; and

FIG. 6 is an exploded view of the first housing, the second housing and the rear cover of the connector of FIG. 5.

### DETAILED DESCRIPTION OF THE INVENTION

The present invention will be apparent from the following detailed description, which proceeds with reference to the accompanying drawings, wherein the same references relate to the same elements.

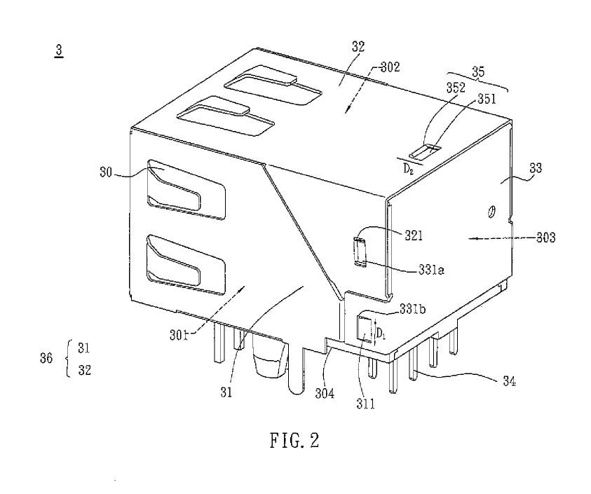

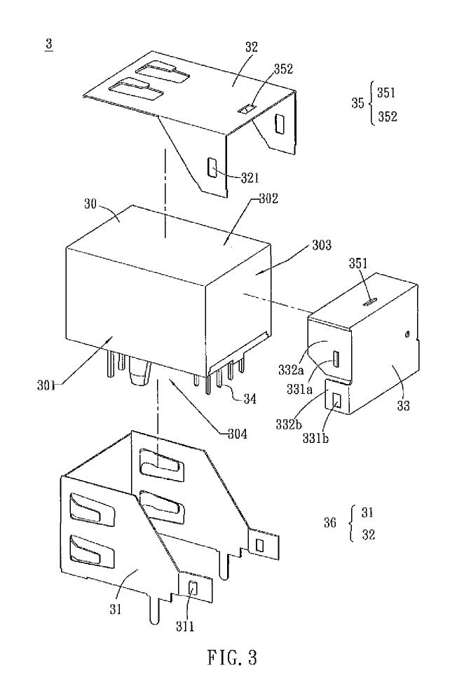

Referring to FIGS. 2 and 3, a connector 3 according to an embodiment of the invention includes a terminal base 30, a main housing 36, a rear cover 33 and a plurality of terminals 34 such as pins. The main housing 36 and the rear cover 33 are usually made of metallic material in order to protect the terminal base 30 from the external electromagnetic interference (EMI). In this embodiment, the connector 3 is, for example but not limited to, an RJ-45 connector. Alternatively, the connector 3 can be an RJ-11 connector, an RJ-12 connector or a USB connector.

The terminal base 30 has a side surface 301, a top surface 302, a back surface 303 and a bottom surface 304 opposite to the top surface 302. The terminal base 30 has a socket 305 and several terminal 34 such as pins. The socket 305 is embedded with several terminals (not shown) electrically coupled to a connecting plug (not shown) for receiving network signals. The terminals 34 are disposed at the bottom surface 304 of the terminal base 30, and the terminals 34 are to be electrically connected to an external circuit (not shown). Thus, a signal received and transmitted by the connector 3 can be transmitted through the terminals 34.

In this embodiment, the main housing 36 includes a first housing 31 and a second housing 32. The main housing 36 formed by a metal piece can be bent to form the first housing 31 and the second housing 32. Only partial surfaces of the first housing 31 and the second housing 32 towards the socket 305 are connected. Alternatively, each of the first housing 31 and the second housing 32 is formed by a metal piece. The first housing 31 covers at least a portion of the side surface 301 of the terminal base 30, and has a first connecting portion 311, which is formed by way of bending or cutting a portion of the first housing 31. In this embodiment, the first connecting portion 311 is formed with a projection by bending the first housing 31. The second housing 32 covers the top surface 302 of the terminal base 30 and at least a portion of the side surface 301, and has a second connecting portion 321, which is formed by bending or cutting a portion of the second housing 32. In this embodiment, the second connecting portion 321 is formed with an opening by cutting the second housing 32. The rear cover 33 covers the back surface 303 of the terminal base 30 and at least a portion of the side surface 301 and at least a portion of the top surface 302, and has two third connecting portions 331a and 331b, each of which is formed by punching or cutting or/and bending a portion of the rear cover 33. In this embodiment, the rear cover 33 is bent to form the third connecting portion 331a to be a projection, and is cut to form the third connecting portion 331b to be an opening.

The first connecting portion 311 and the third connecting portion 331b are engaged to the side surface 301 of the terminal base 30 and firmly engaged with the first housing 31 and the rear cover 33 to cover the terminal base 30 and prevent the first housing 31 and the rear cover 33 from relatively moving along a first direction D₁. The second connecting portion 321 and the third connecting portion 331a are engaged to the side surface 301 of the terminal base 30, and firmly engaged with the second housing 32 and the rear cover 33 to cover the terminal base 30. Therefore, the third connecting portion 331b engages with the first connecting portion 311, and the second connecting portion 321 engages with the third connecting portion 331a, so that the rear cover 33 engages with the first housing 31 and the second housing 32 engages with the rear cover 33. Thus, the main housing 36 and the rear cover 33 can engage with one another to completely cover the terminal base 30.

Furthermore, in this embodiment, the rear cover 33 has a first cover 332a with the third connecting portion 331a, and a second cover 332b with the third connecting portion 3311b. The second cover 332b of the rear cover 33 covers the first housing 31 so that the first connecting portion 311 engages with the third connecting portion 331b. The first cover 332a of the rear cover 33 is covered by the second housing 32 so that the third connecting portion 331a engages with the second connecting portion 321. Therefore, by the rigidity of metallic material and the connecting portions, the rear cover 33 fixedly engages with the main housing 36.

In addition, the connector 3 further includes a stopper 35, which is disposed on the top surface 302 of the terminal base 30 and connected to the second housing 32 and the rear cover 33 to stop the second housing 32 and the rear cover 33. Thus, the second housing 32 and the rear cover 33 can be prevented from relatively moving along a second direction D₂. In this case, the stopper 35 may also prevent the second housing 32 and the rear cover 33 from relatively moving along the second direction D₂. In this embodiment, the stopper 35 includes a projection 351 and a locking portion 352, which are correspondingly disposed on the rear cover 33 and the second housing 32, respectively. The projection 351 is formed by bending the rear cover 33, and the locking portion 352 is an opening formed by cutting the second housing 32. The projection 351 engaging with the locking portion 352 can stop the second housing 32 and the rear cover 33 from relatively moving along the second direction D₂. The projection 351 can have an inclined surface to be conveniently connected to the locking portion 352. The projection 351 can have a triangular cross-section, a rectangular cross-section, a trapezoidal cross-section, an arced cross-section, a polygonal cross-section or an irregular cross-section.

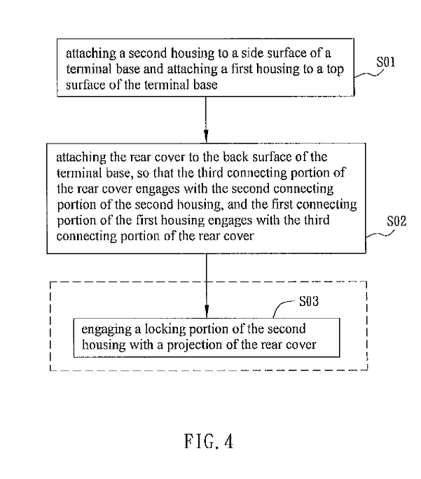

Referring to FIG. 4, a method of assembling the connector according to the embodiment of the invention includes the following steps 801 and S02. In step S01, the second housing 32 is attached to the side surface of the terminal base 30 and the first housing 31 is attached to the top surface of the terminal base 30. In step S02, the rear cover 33 is attached to the back surface 303 of the terminal base 30, the third connecting portion 331a of the rear cover 33 engages with the second connecting portion 321 of the second housing 32, and the first connecting portion 311 of the first housing 31 engages with the third connecting portion 331b of the rear cover 33.

In addition, the method can further include the step S03 for engaging the locking portion 352 of the second housing 32 with the projection 351 of the rear cover 33. The assembling method of the invention has been described in the above-mentioned embodiment, so detailed descriptions thereof will be omitted.

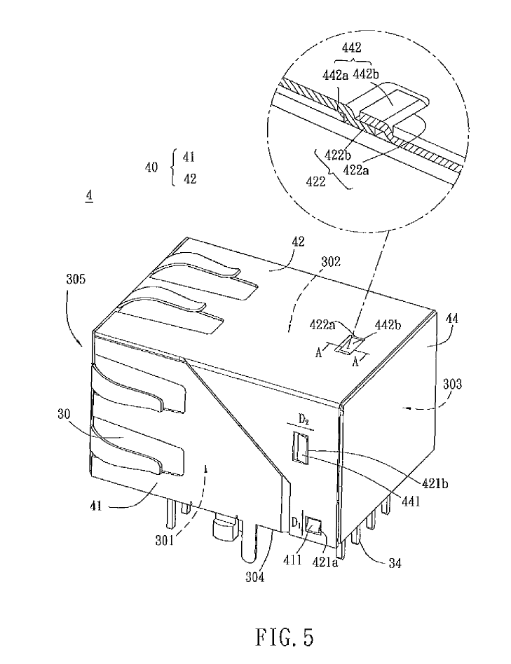

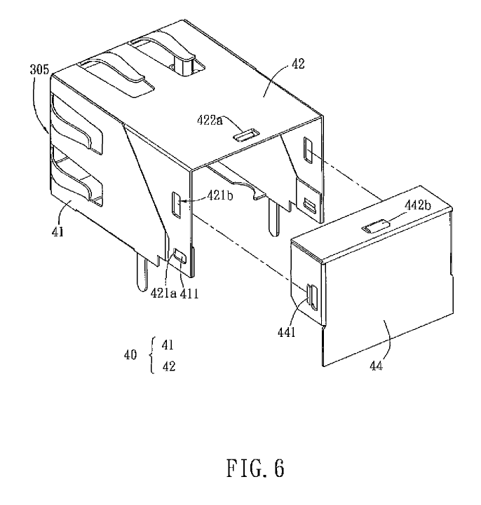

With reference to FIGS. 5 and 6, a connector 4 according to another embodiment of the invention includes a terminal base 30, a main housing 40, and a rear cover 44.

In this embodiment, the main housing 40 includes a first housing 41 and a second housing 42. The main housing 40 formed by a metal piece to be bent to form the first housing 41 and the second housing 42. Only partial surfaces of the first housing 41 and the second housing 42 towards the socket 305 are connected. Alternatively, each of the first housing 41 and the second housing 42 is formed by a metal piece. The first housing 41 covers at least a portion of the side surface 301 of the terminal base 30, and has a first connecting portion 411, which is a protruding member formed by bending or cutting a portion of the first housing 41. The second housing 42 covers the top surface 302 of the terminal base 30 and at least a portion of the side surface 301, and has two second connecting portions 421a, 421b, each of which is a buckling member formed by punching or cutting a portion of the second housing 42. The rear cover 44 covers the back surface 303 of the terminal base 30 and at least a portion of the side surface 301 and at least a portion of the top surface 302, and has a third connecting portion 441, which is a protruding member formed by punching or cutting and bending a portion of the rear cover 44. By engaging the first connecting portion 411 with the second connecting portion 421a, the motion of the first housing 41 and the second housing 42 in the first direction D₁ is restricted. By engaging the third connecting portion 441 with the second connecting portion 421b, the motion of the second housing 42 and the rear cover 44 in the first direction D₂ is restricted. The first direction D₁ and the second direction D₂ are not parallel to each other. Preferably, the first direction D₁ and the second direction D₂ are perpendicular to each other. In this embodiment, the above-mentioned protruding member can be a protruding structure or polyhedron such as projection with a slant or guiding surface. The above-mentioned buckling member has a shape corresponding to the protruding member, for example, an opening. The cross section of the protruding member can be triangular, rectangular, trapezoidal, arced, polygonal or irregular.

Therefore, the second housing 42 covers a portion of the first housing 41 and a portion of the rear cover 44. The first housing 41 and the second housing 42 are connected at the overlapping portion of the first housing 41 and the second housing 42. The second housing 42 and the rear cover 44 are connected at the overlapping portion of the second housing 42 and the rear cover 44. By the rigidity of metallic material and the connecting portions, the main housing 40 engages with the rear cover 44 to completely cover the terminal base 30.

The connector 4 further comprises at least one stopper for stopping the second housing 42 and the rear cover 44 from relatively moving. The stopper comprises a first stopping portion 422 and a second stopping portion 442 correspondingly disposed on the second housing 42 and rear cover 44, respectively. The first stopping portion 422 has a locking part 422a and a bending part 422b. The second stopping portion 442 has a locking part 442a and a bending part 442b. The bending part 422b of the first stopping portion 422 is inserted into the locking part 442a of the second stopping portion 442. The bending part 442b of the second stopping portion 442 is inserted into the locking part 422a of the first stopping portion 422. Thus, the first and second stopping portions 422, 442 lock each other to stop the second housing 42 and the rear cover 44 from moving relatively. The first and second stopping portion 422, 442 are formed by punching or/and cutting or/and bending a portion of the second housing 42 and a portion of the rear cover 44.

In summary, the invention utilizes the simplified connecting structure of the housings to achieve the connection. Thus, the interference of the pins can be prevented, the production precision and cost are both reduced, and the signal transmission interference can be avoided, thereby increasing the reliability of the connector.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A connector comprising:
a terminal base having a plurality of terminals disposed at a bottom surface of the terminal base;
a main housing having a first connecting portion and a second connecting portion; and
a rear cover having two third connecting portions respectively engaging with the first connecting portion and the second connecting portion so as to combine the main housing and the rear cover to cover the terminal base.

2. The connector according to claim 1, wherein:
the first connecting portion is formed by punching or/and cutting or/and bending a portion of the main housing;
the second connecting portion is formed by punching or/and cutting or/and bending a portion of the main housing; and
the third connecting portions are formed by punching or/and cutting or/and bending a portion of the rear cover.

3. The connector according to claim 1, wherein the main housing comprises a first housing with the first connecting portion and a second housing with the second connecting portion.

4. The connector according to claim 3, wherein the main housing is formed by a metal piece to be bent to form the first housing and the second housing.

5. The connector according to claim 3, wherein the first housing covers at least a portion of a side surface of the terminal base, the second housing covers a top surface of the terminal base and at least a portion of the side surface of the terminal base, and the rear cover covers a back surface of the terminal base and at least a portion of the side surface of the terminal base and at least a portion of the top surface of the terminal base.

6. The connector according to claim 3, wherein the first connecting portion and one of the third connecting portion engaging with the first connecting portion are a projection and an opening, respectively, and the other one of the third connecting portion and the second connecting portion engaging with the other one of the third connecting portion are a projection and an opening, respectively.

7. The connector according to claim 1, further comprising at least one stopper for stopping the main housing and the rear cover from relatively moving.

8. The connector according to claim 7, wherein the stopper comprises a projection and a locking portion disposed on the rear cover and the second housing, respectively.

9. The connector according to claim 7, wherein the stopper is formed by bending or cutting a portion of the main housing and a portion of the rear cover.

10. The connector according to claim 7, wherein a cross-section of the projection is triangular, rectangular, trapezoidal, arced, polygonal or irregular, and the projection has an inclined surface.

11. A connector comprising:
a terminal base having a plurality of terminals disposed at a bottom surface of the terminal base;
a first housing with a first connecting portion and a second housing with two connection portions; and
a rear cover having a third connecting portion, wherein the two second connecting portions are engaged with the first connecting portion and the third connecting portion, respectively so that the first and the second housings and the rear cover are assembled to cover the terminal base.

12. The connector according to claim 11, wherein each of the first and the second housings is formed by a metal piece.

13. The connector according to claim 11, wherein the first housing covers at least a portion of a side surface of the terminal base, the second housing covers a top surface of the terminal base and at least a portion of the side surface of the terminal base, and the rear cover covers a back surface of the terminal base and at least a portion of the side surface of the terminal base and at least a portion of the top surface of the terminal base.

14. The connector according to claim 11, wherein:
the first connecting portion is formed by punching or/and cutting or/and bending a portion of the first housing;
the second connecting portions are formed by punching or/and bending or/and cutting a portion of the second housing; and
the third connecting portion is formed by punching or/and bending or/and cutting a portion of the rear cover.

15. The connector according to claim 11, wherein the first connecting portion and one of the second connecting portion engaging with the first connecting portion are a projection and an opening respectively, and the other one of the third connecting portion and the second connecting portion engaging with the other one of the third connecting portion are an opening and a projection respectively.

16. The connector according to claim 15, wherein a cross-section of the projection is triangular, rectangular, trapezoidal, arced, polygonal or irregular, and the projection has an inclined surface.

17. The connector according to claim 11, further comprising at least one stopper for stopping the second housing and the rear cover from relatively moving.

18. The connector according to claim 17, wherein the stopper comprises a first stopping portion and a second stopping portion correspondingly disposed on the second housing and rear cover; respectively.

19. The connector according to claim 18, wherein each of the first and second stopping portions has a locking part and a bending part, wherein the bending part of the first stopping portion is inserted into the locking part of the second stopping portion, and the bending part of the second stopping portion is inserted into the locking part of the first stopping portion.

20. The connector according to claim 18, wherein the first and second stopping portions are formed by punching or/and cutting or/and bending a portion of the second housing and a portion of the rear cover.

21. A connector comprising:
a terminal base;
a main housing having a first connecting portion; and
a rear cover having a second connecting portion engaged with the first connecting portion to assemble the main housing and the rear cover for covering the terminal base.
